(19) United States
(12) Patent Application Publication
(10) Pub. No.: US 2007/0004825 A1
(43) Pub. Date: Jan. 4, 2007

(54) Reactive diluents

(75) Inventors: Benjamin Patrick Gracey, Hull (GB); Christopher Hatlett, Hertfordshire (GB)

Correspondence Address: WELSH & KATZ, LTD, 120 S RIVERSIDE PLAZA, 22ND FLOOR, CHICAGO, IL, 60606, US

(73) Assignee: The University of Southern Mississippi, Hattiesburg (US)

(21) Appl. No.: 10/555,901

(22) PCT Filed: May 7, 2004
(86) PCT No.: PCT/GB04/01986

§ 371 Date: Nov. 7, 2005

(30) Foreign Application Priority Data
May 8, 2003 (GB) 0310622.6
May 8, 2003 (GB) 0310623.4

(51) Int. Cl. C08K 5/13

(52) U.S. Cl. 523/510

(57) ABSTRACT

Allyloxy esters, RₙM(OR′)ₓ(OR″)_{y}, wherein M is silicon, carbon, boron or titanium, R is hydrogen or a hydrocarbyl group, R′ are allylic unsaturated hydrocarbyl or hydrocarbyloxy hydrocarbyl groups, R″ are saturated analogues of R′, and x is at least 1 and y may be zero, and n+x+y=3 if M is boron, and n+x+y=4 if M is silicon, carbon, or titanium, are used as reactive diluents in paint or coating formulations.

### BACKGROUND OF THE INVENTION

This invention relates to allyloxy derivatives of silicon, carbon, boron and titanium, a method of preparation thereof, and the use thereof as reactive diluents in coating and paint formulations.

Reactive diluents are usually compounds or mixtures of compounds of relatively low viscosity and relatively high boiling point (or low saturated vapour pressure) which act as solvents during the formulation and processing of paints and coatings. An advantage of reactive diluents is that such diluents are able to copolymerise with components of an alkyd resin. Hence reactive diluents may be used to replace part or all of the traditional solvents normally used in such formulations thereby reducing losses of the solvent to atmosphere on drying of the coating. Use of esters of di- and polyhydric alcohols that have been partially etherified with allyl alcohol as reactive diluents is described in EP-A-0 253 474. However, these esters have relatively high viscosity of around 0.5 poise (50 millipascal seconds) and therefore can be used only in a limited number of paint formulations. Moreover, allyl alcohol esters also are susceptible to hydrolysis and are therefore capable of releasing undesirable allyl alcohol. In addition, when polymer formulations containing the esters partially etherified with allyl alcohol are subjected to curing using radical conditions, there is a risk of fragmentation of the molecule, which may release undesirable acrolein vapours. During use as solvents, the fragmentation products of higher allylic alcohols, e.g. octadienol, are much less volatile and are therefore less hazardous to persons in proximity to these materials.

Alkyd resins are well-known components of decorative paints (see, for example, “The Technology of Paints, Varnishes and Lacquers” by Martens, C R, Ed., published by Robert Krieger Publishing (1974)) and can be prepared from polybasic acids or anhydrides, polyhydric alcohols and fatty acids or oils. U.S. Pat. No. 3,819,720, incorporated by reference herein, describes methods of preparing such alkyd formulations. Alkyd resins are available commercially and are used in coating compositions which usually contain large amounts of solvents (e.g. mineral spirits, aromatic hydrocarbons). Other types of paint and coating formulations have been based on fatty acid modified acrylates, unsaturated polyesters and those that have relatively high solids content.

Allyloxy derivatives have been described for use as reactive diluents in U.S. Pat. Nos. 6,130,275 and 6,103,801 and by Zabel et al., Progress in Organic Chemistry 35 (1999) 255-264).

It has now been found that certain specific allyloxy derivatives of boron, titanium, silicon, and carbon may be produced in commercially viable yields and purity and have excellent performance as reactive diluents in various paints and coating formulations.

### SUMMARY OF THE INVENTION

Allyloxy esters, RₙM(OR′)ₓ(OR″)_{y}, wherein M is silicon, carbon, boron or titanium, R is hydrogen or a hydrocarbyl group, R′ are allylic unsaturated hydrocarbyl or hydrocarbyloxy hydrocarbyl groups, R″ are saturated analogues of R′, and x is at least 1 and y may be zero, and n+x+y=3 if M is boron, and n+x+y=4 if M is silicon, carbon, or titanium, are used as reactive diluents in paint or coating formulations.

### DESCRIPTION OF THE INVENTION

In one aspect of this invention, allyloxy titanates and allyloxyborates are prepared, which may be used as reactive diluents for paint or coating formulations.

The reactive diluent of this invention includes one or more allyloxy derivatives of the formula:
RₙM(OR′)ₓ(OR″)_{y} (I)

wherein

M is selected from silicon, carbon, boron, and titanium;

R is selected from hydrogen and from hydrocarbyl and alkoxy groups containing up to 10 carbon atoms;

R′ are selected from unsaturated hydrocarbyl or hydrocarbyloxy hydrocarbyl groups containing up to 22 carbon atoms, provided when M is boron or titanium, at least one R′ is a hydrocarbyloxy hydrocarbyl group;

R″ are selected from saturated analogues of R′; and

n=0 or 1 for carbon and silicon and =0 for boron and titanium.

x and y are numerical values for which x is at least 1 and y may be zero such that
if M is boron, n+x+y=3, and
if M is silicon, carbon, or titanium, n+x+y=4.

For a specific compound of this invention, the values of x and y are integers with their sum reflecting the valence of M; however, a bulk quantity of these compounds may have fractional measured values that represent a mixture of specific compounds with varying values for x and y.

In compounds of this invention represented by formula (I) illustrated above, R′ is suitably derived from allylic alcohol represented as:

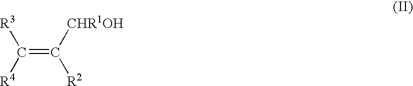

in which
R¹ is H or a C₁-C₄ alkyl group or a hydrocarbyloxy alkyl group containing up to 10 carbon atoms,
R² is H or a C₁-C₄ alkyl group or a hydrocarbyloxy alkyl group containing up to 10 carbon atoms,
R³ is H or a C₁-C₄ alkyl group,
R⁴ is H, a straight or branched chain alkyl group having up to 8 carbon atoms,
   an alkenyl group having up to 8 carbon atoms,
   an aryl group or an aralkyl group having up to 12 carbon atoms, or
   a hydrocarbyloxy alkyl group having up to 10 carbon atoms, or,
R⁴, when taken together with R¹, forms a cyclic alkylene group with alkyl substituents therein and in which case R² is H.

In typical allylic alcohol derivatives useful in this invention, R¹, R² and R³ are selected individually from hydrogen, methyl, and ethyl groups. Again, in typical allylic alcohol derivatives useful in this invention, R⁴ is selected from alkenyl groups containing up to 7 carbon atoms preferably containing terminal unsaturation such as a but-3-enyl, pent-4-enyl, and hex-5-enyl groups. In other typical allylic alcohol derivatives, R⁴ may be alkoxy or alkoxyalkylene containing up to 7 carbon atoms, such as t-butoxy, t-butoxymethylene, iso-propoxy, ethoxy, methoxy, and the like.

Preferable allylic alcohols have less steric hindrance around the carbon-carbon double bond, which promotes reactivity with the coating resin. However, since a suitable reactive diluent has a high vapour pressure, preferable allylic alcohol starting compounds are substituted. For example, R¹ can be sec-butenyl and R², R³, and R⁴ are hydrogen. If an allylic alcohol is not alkoxylated, C₈₋₁₀ alcohols are preferred, while C₄₋₆ alkoxylated derivatives are useful.

The reactant allylic alcohol, R′OH used to produce the allyloxy derivatives of the present invention can be prepared in several ways known to those skilled in the art. For instance, octadienol may be prepare by telomerisation of butadiene and water, which yields a mixture of isomers (predominantly 2,7-octadien-1-ol and a minor amount of 1,7-octadien-3-ol). Alternatively, the reactant allylic alcohol and the saturated analogue R″OH can be produced by the reduction of the corresponding α,β-unsaturated aldehyde, e.g., by hydrogenation, which will generate a mixture of the allylic alcohol and its saturated analogue. Some other allylic alcohols may be produced from conjugated dienes via the well known addition reactions. Furthermore, other allylic alcohols may be produced by initially forming an unsaturated ester from an olefin and a carboxylic acid followed by hydrolysis of the ester. This latter reaction may, like some of the other reactions mentioned above, result in a mixture of products which includes inter alia the desired allylic alcohol, isomers thereof and saturated analogues thereof. Mixtures of allylic alcohol with the saturated analogues thereof and/or the isomers thereof can be then used as such, or after further purification to isolate the desired allylic alcohol, to prepare the allyloxy derivatives of boron and titanium represented by formula (I) above.

Through varying the substitution of the allylic alcohols, reactive diluents with optimised properties may be prepared. Forming alkoxylated derivatives using an alkylene oxide such as ethylene oxide or propylene oxide and differing proportions of such alkylene oxides produce reactive diluents with varying solvating properties. Thus, a reactive diluent may be tailored to a specific coating resin. The solvating properties may be associated with the oxygen content of diluent as known by those skilled in the art. Reactive diluents prepared according to this invention may contain varying amounts of glycol ether functionality which will affect water miscibility.

Compounds prepared by a modification of the above method in which an alkoxylated or aryloxylated allylic alcohol was used as the reactant include at least one ligand group derived from an allyl ether alcohol attached to a central boron or titanium atom (M) and have the general formula:
[R*(OCR⁶R⁷—CR⁸R⁹)ₚ O]ₙ-M (III)
wherein:
R* is an saturated or unsaturated hydrocarbyl or hydrocarbyloxy hydrocarbyl group containing up to 22 carbon atoms, provided that in at least one ligand group, R* contains at least one allylic unsaturation;
M is boron (III), titanium (IV), silicon or carbon;

R⁶, R⁷, R⁸, and R⁹ are selected individually from hydrogen and alkyl, alkylene, and aryl groups containing up to 10 carbon atoms;
n is the valence of M; and
p is 0 to 5, provided that p is 1 for at least one ligand group.

For carbon and silicon derivatives, hydrogen or a C₁-C₁₀ hydrocarbyl group may be substituted for one allyloxy group.

The allylic alcohols can be converted to the corresponding allylic ether alcohols by reaction with an olefin oxide or an arylene oxide in the presence of a suitable catalyst. This reaction will result in a product which has a hydroxyalkylene group, a polyoxyalkylene group, a hydroxyarylene group or a polyoxyarylene group attached to the oxygen atom of the starting allylic alcohol.

The ethers of allylic alcohols may be derived either by alkoxylation of the allylic alcohol or, in the case of the ethers of octadienol, by telomerisation. The groups R⁶, R⁷, R⁸ and R⁹ in Formula I typically are derived from an epoxide which is reacted with the allylic alcohol suitably in the presence of a suitable catalyst to form the hydroxy ether.

The epoxidation reaction to form the hydroxy ether can be carried out using one or more of the epoxides which include inter alia ethylene oxide, propylene oxide, butadiene mono-oxide, cyclohexene oxide and styrene oxide. The amount of epoxide used for this step would depend upon the number of alkoxy groups desired in the hydroxy ether. The amount of epoxide used is suitably in the range from 0.1 to 20 moles, preferably from 1 to 5 moles based on the allylic alcohol reactant.

The epoxidation step suitably is carried out in the presence of a base catalyst. Examples of base catalysts that may be used include alkali metal hydroxides and alkoxides such as sodium or potassium hydroxide and alkoxide and other metal salts such as potassium acetate. A typical base catalyst is potassium t-butyl butoxide.

The epoxidation reaction is suitably carried out at a temperature in the range from 50 to 180° C., preferably from 60 to 140° C., and typically is conducted in a suitable non-reactive diluent such as a liquid alkane or cycloalkane. The reaction pressure for this step is suitably autogenous and preferably is from 100 to 700 KPa.

The hydroxy ether formed in this step typically is separated from the reaction mixture-by-use of a suitable neutralisation agent, such as magnesium silicate, then filtered to remove the neutralising agent and the salt of neutralisation so formed to leave behind filtrate comprising the desired hydroxy ether.

The hydroxy ether so produced in the first step can be used either as such without purification, or, optionally, after purification (e.g. by distillation) for the esterification stage.

In another representation of this invention, the allylic ether alcohol used to form the reactive diluent of formula (II) may be illustrated as:
R′OH
in which R′ is R*(OCR⁶R⁷—CR⁸R⁹)ₚ with p=0-5 and has the same use as represented in formula (I).

As stated above, the compounds of this invention may be prepared by reacting an allylic alcohol (R′OH) with a compound of boron or titanium each of which have three or four ligands as appropriate for their respective valences such as an alkoxy or halo group attached thereto to produce the substituted derivatives of the appropriate central atom M.

The reaction between an allylic alcohol including allylic ether alcohols and an M-Xₙ derivative such as a halide or alkoxide is suitably carried out in an inert and dry atmosphere by purging oxygen, other oxidising gas, or moisture out of the system by means of an inert gas such as a nitrogen sparge. Once degassed, the M-Xₙ derivative is added.

In a typical process to form a borate or titanate derivative of this invention, an allylic alcohol is reacted with a trivalent boron or titanium tetravalent salt (M-Xₙ) such as a halide or alkoxide (preferably a C₁-C₅ alkoxide) to form an allylic borate or titanate. In the representation, M-Xₙ, M is boron or titanium, X are suitable ligands selected from halides and alkoxides and n is the valence of M. Typical examples of boron and titanium salts useful in this invention include boron trichloride, boron tribromide, titanium tetrachloride, titanium tetrebromide, titanium tetramethoxide, titanium tetraethoxide, triethylborate, and trimethylborate. The ligand of the respective boron or titanium salt must be capable of being exchanged with an allyl alcohol under suitable reaction conditions form the allyl borates or titanates of this invention. Preferably, the initial ligand is removed from the reaction system as a free alcohol or insoluble salt, which drives the exchange reaction to completion.

The central atom M is selected from boron of valence 3, B(III), and titanium of valence 4, Ti(IV). Thus, boron-containing derivatives of the present invention may be termed as alkenyl borates or allyloxy boranes and titanium-containing derivatives termed alkenyl titanates and are more specifically represented as:
Ti(OR′)₄—a tetra-allyl titanate
B(OR′)₃—a tri-allyloxy borane (or tri-allyl borate)

Specific examples of allylic alcohols of formula (II) include inter alia 2,7-octadienol (in which R¹, R² and R³ are H, and R⁴ is a pent-4-enyl group); 2-ethyl-hex-2-en-1-ol (in which R¹ and R³ are H, R² is an ethyl group, and R⁴ is an n-propyl group, and which compound will hereafter be referred to as “2-ethyl hexenol” for convenience); 2-ethyl allyl alcohol; hept-3-en-2-ol; 1,4-but-2-ene diol mono-tertiary butyl ether (in which R⁴ is a tertiary butoxy methylene group); 1,4-but-2-ene-diol mono α-methylbenzyloxy ether (in which R⁴ is an α-methylbenzyloxy group); 1,4-but-2-ene-diol mono α-di methylbenzyloxy ether (in which R⁴ is an α-dimethylbenzyloxy group); 1,2-but-3-ene-diol mono hydrocarbyloxy alkylene ether (i.e. R¹=a hydrocarbyloxy alkylene group and R², R³ and R⁴=H); 2-hydrocarbyloxy alkylene allyl alcohol (i.e. R¹, R³ and R⁴=H and R²=hydrocarbyloxy alkylene group); cinnamyl alcohol; and isophorol (in which R² is H, R³ is a methyl group, and R¹ and R⁴ are such that R⁴ represents a —CH₂—C(CH₃)₂—CH₂— and forms a cyclic structure with R¹).

Preparation of the compounds of formula (I) involves substitution of ligands/groups bound to the central boron or titanium atoms of the compounds used as reactants (such as an alkoxy in a tetraalkyl titanate or trialkyl borate, or a chloro group in titanium or boron chlorides) with the desired allylic alcohol groups. Hence, those skilled in the art understand that the final product may contain some molecules in which the original ligands/groups bound to the central atom are unreacted.

These compounds typically are prepared by reacting an allylic alcohol (R′OH) with an alkoxy borane/alkyl titanate or the appropriate chloro compound to produce the corresponding metal allyloxy derivatives.

A reaction between an allylic alcohol or an allylic ether alcohol and an M-alkoxy compound is suitably carried out in an inert and dry atmosphere by purging the oxygen, other oxidising gasses, and moisture out of the system by means of an inert gas such as a nitrogen sparge. Once degassed, the M-alkoxy is added under suitable reaction conditions to form the product of this invention. For example, a typical procedure in using primary alcohols includes evacuating the reaction mixture to a pressure below atmospheric, such as about 2 KPa (20 mbar,) and suitably heating to moderate temperatures below decomposition temperature, such as 80° C., for about two hours. During this reaction, any displaced alcohol may be collected from the top of the distillation column. The reaction temperature then may be suitably raised, to about 120° C., and held for a further duration of about 4 hours to complete the reaction. The applied vacuum may be increased to about 0.1 KPa (1 mbar) to distill over any unreacted alcohol together with a minor by-product of carboxylate ester of the alcohol. It was found that use of a vacuum for the reaction was beneficial to reduce the amount of side reactions. However, care should be taken since use of a relatively low vacuum of about 0.1 KPa (1 mbar) at the start of the reaction caused sublimation of the reactant M-alkoxy compound.

Typically, only one equivalent of the allylic alcohol or allylic ether alcohol per alkoxy group in the reactant M-alkoxy derivative is needed, since the involatility of the allylic alcohols, such as ethoxylated allylic alcohols, precludes removal by distillation of any excess allylic alcohol. Prior to heating to 80° C., the mixture may be allowed to “pre-equilibrate” at room temperature for 2 hours at 0.1 KPa (1 mbar) and all subsequent stages can be carried out at 0.1 KPa (1 mbar). The low temperature pre-equilibration served to prevent sublimation of the reagent M-alkoxy derivative. Persons of skill in the art will recognize that these typical temperatures, pressures, reaction times, and reaction media may be varied to achieve acceptable results.

The following compounds were prepared by this method (note only the major isomer is named in these compounds):
Tri-(2-ethyl allyl)borate
Tri-(mesityl)borate (using mesityl alcohol)
Tri-(2,7-octadienyl)borate
Tri-(2-ethylhex-2-enyl)borate
Tri-(3,5,5-trimethyl-2-cyclohexen-1-yl)borate
Tri-(2-(2,7-octadienoxy)ethyl)borate
Tri-(2-(2-(2,7-octadienoxy)ethoxy)ethyl)borate
Tetra-(2,7-octadienyl)titanate
Tetra-(2-ethylhex-2-enyl)titanate
Tetra-(2-(2,7-octadienoxy)ethyl)titanate

The allyloxy derivatives of boron and titanium of the present invention have low volatility and low viscosity which can be as low as that of white spirit. For instance, the viscosity of these derivatives is typically below 1500 mPa·s (millipascal seconds), more typically below 150 mPa·s and especially below 110 mPa·s, and more particularly below 35 mPa·s thereby rendering them a suitable reactive diluent for cured paint and polymer formulations, especially for formulations comprising alkyd resins. Hence, they are particularly suitable for use as reactive diluents in formulations for polymeric paints and coatings. Thus, for example, tri-octadienoxy borane derived by the reaction of a tri-ethyl borate with octadienol has a viscosity of 11.2 mPa·s whereas tri-(2-ethyl hexenoxy) borane has a viscosity of 7.2 mPa·s.

The allyloxy derivatives of silicon and carbon of formula (I) of the present invention can be more specifically represented by the following compounds:
Si(OR′)₄—an ortho-silicate
R—Si(OR′)₃—an allyloxy silane
C(OR′)₄—an ortho-carbonate
R—C(OR′)₃—an ortho-formate (when R═H) or an ortho-ester
   (when R=a group other than H).

As stated above, these compounds can be prepared e.g. by displacing an alkoxy, a halo or a carboxy group in an alkoxy silane, a chloro silane or a carboxy silane with an allylic alcohol (R′OH) i.e. using e.g. acetoxy silane to produce the substituted silicon derivatives and with an alkyl formate or an alkyl carbonate to produce the corresponding carbon derivatives. R preferably is hydrogen or a C₁-C₄ alkyl group.

Where the reaction is between the allylic alcohol and a carboxy silane, this is suitably carried out in an inert and dry atmosphere e.g. by purging the oxygen, other oxidising gases and moisture out of the system by means of an inert gas such as e.g. a nitrogen sparge. Once degassed, the carboxy silane is added. During the reaction, the conditions are suitably so chosen that an esterification reaction between the by-product carboxylic acid from the carboxy silane and the allylic alcohol is avoided or at least minimised by continually removing any carboxylic acid formed during the reaction. For instance, in the case of primary alcohols, the reaction mixture is suitably evacuated to a pressure below atmospheric e.g. about 2 KPa (20 mbar) and suitably heated to moderate temperatures, e.g. 80° C., for a duration, e.g. two hours. During this reaction, any displaced acetic acid can be collected from the top of the column. The reaction temperature is then suitably raised, e.g. to about 120° C., and suitably held for a further duration, e.g. 4 hrs, to complete the reaction. The applied vacuum is then suitably increased, e.g. to about 0.1 KPa (1 mbar) to distil over any unreacted alcohol together with a minor by-product of carboxylate ester of the alcohol. It is found that use of a vacuum for the reaction was beneficial as it reduced the amount of esterification. Care should be taken since it was also found that application of a relatively low vacuum of about 0.1 KPa (1 mbar) at the start of the reaction caused sublimation of the silane reactant.

In some cases, e.g. when the allylic ether alcohol has a relatively high boiling point, it is preferable to use only 1 equivalent of the allylic ether alcohol per carboxy-group since the involatility of the allylic ether alcohol such as e.g. the ethoxylated allylic alcohols may preclude removal by distillation of any excess alcohol. Prior to heating to the reaction temperature, e.g. 80° C., the mixture can be allowed to “pre-equilibrate” at room temperature for a time, e.g. 2 hours, at 0.1 KPa (1 mbar) and all subsequent stages can be carried out at 0.1 KPa (1 mbar). The low temperature pre-equilibration served to prevent loss of the reactant carboxy silane.

The progress of the reaction and distillation can be monitored by gas chromatography. A target of less than 2% free alcohol in the kettle product is suitably set. Once this has been achieved the reaction mixture can be allowed to cool to room temperature and filtered through a short bed of celite filter aid to remove any traces of silica/hydrated silicon oxides. The silicon acetate so formed can contain as an impurity some silica. Additional silica may be formed during the course of the reaction if esterification and consequent water production (hydrolysis) is not kept to a minimum. The identity of the product was confirmed in each case by ¹H, ¹³C and ²⁹Si NMR spectroscopic analysis.

The following compounds were prepared by this method:
Methyl tri-(2,7-octadienoxy)silane
Tetra-(2,7-octadienoxy)silane
Methyl-tri-(2-ethyl hex-2-enoxy)silane
Tetra-(2-ethyl hex-2-enoxy)silane
Methyl tri-(3,5,5-trimethyl-2-cyclohexen-1-oxy)silane
Tetra-(3,5,5-trimethyl-2-cyclohexen-1-oxy)silane
Tetra(4-tert-butoxy-but-2-en-1-oxy)silane
Methyl tri-(2-ethyl allyl-1-oxy)silane
Tetra(2-ethyl allyl-1-oxy)silane
2-ethyl hexenyl ortho-formate
Octadienyl ortho-formate
   Examples of compounds falling within the formula (III) above are:
Methyl tri-(2-(2,7-octadienoxy)ethoxy)silane
Tetra-(2-(2,7-octadienoxy)ethoxy)silane
Methyl tri-(2-(2-(2,7-octadienoxy)ethoxy)ethoxy)silane
Tetra-(2-(2-(2,7-octadienoxy)ethoxy)ethoxy)silane
Tetra-(1-(2,7-octadienoxy)propan-2-oxy)silane
Tetra-(1-(2-ethyl hex-2-en-1-oxy)propan-2-oxy)silane
Tetra-(1-(1-(2-ethyl hex-2-en-1-oxy)propan-2-oxy)propan-2-oxy)silane
2-(2,7-octadidenoxy ethyl)orthoformate
Bis(2,7-octadienoxy)bis [2-(2,7-octadienoxy)ethoxy]silane

It should be noted that the preparation of these compounds of formula (I) involves substitution of the ligands/groups bound to the central silicon or carbon atoms of the compounds used as reactants (such as an alkoxy in a tetra alkyl ortho-silicate or the carboxy groups in a tetra-carboxy silane) with the desired allylic alcohol groups. Hence, it will be understood by those skilled in the art that the final product may contain some molecules in which the original ligands/groups bound to the central atom are unreacted.

The substituted derivatives of silicon and carbon of the present invention have low volatility and relatively low viscosity which can be as low as that of white spirit. For instance, the viscosity of these derivatives is suitably below 1500 mPas, typically below 150 mPa·s and especially below 110 mPas, and more particularly below 35 mPa·s thereby rendering them a suitable reactive diluent for cured paint and polymer formulations, especially for formulations comprising alkyd resins. Hence, they are particularly suitable for use as reactive diluents in formulations for polymeric paints and coatings. Thus, e.g. methyl tri-octadienoxy-silane derived by the reaction of a carboxy silane with octadienol has a viscosity of 5.5 mPa·s whereas methyl tri-(2-ethyl henenoxy)silane has a viscosity of 5.9 mPa·s. The 2-ethyl hexenyl orthoformate has a viscosity of 4.69 mPa·s.

A typical reactive diluent of this invention has a boiling point above 250° C. and more typically above 300° C. A higher boiling point or a higher vapour pressure typically is indicative of a material with less odour. Thus, an allylic higher molecular weight derivative containing more carbon atoms will reduce odour and reduce volatile organics which may be environmentally detrimental. However, a higher molecular weight material will dilute the reactive sites and typically increase viscosity. Thus, a balance of properties typically is preferred.

In addition to increasing molecular weight, a reactive diluent formed from an allylic alcohol that has been capped or alkoxylated with an epoxide typically will have improved reactivity due to electronegativity effects of the glycol ether on the carbon-carbon double bond. Another advantage of alkoxylated alcohol derivatives is reduced likelihood of production of undesirable acrolein (2-propenal) species. Also, such derivatives typically require reduced amounts of a drying agent. An advantage of forming alkoxylated derivatives is that lower molecular weight starting allylic alcohols may be used, which are more widely available and less costly.

The compositions of the present invention are highly suitable for use as reactive diluents, especially in combination with a coating resin.

The relative proportions of the compounds of this invention used as reactive diluents to the alkyd resin in a formulation can be derived from the ranges quoted in published EP-A-0 305 006, incorporated by reference herein. In an example in which the reactive diluents of the present invention replaces all of the traditional solvent, the proportion of reactive diluent to alkyd resin is suitably at least 5:95 parts by weight and may extend to 50:50 parts by weight. A preferable proportion of reactive diluent to alkyd resin is up to 25:75, and more preferably is up to 15:85, parts by weight.

In addition to the formulations described in this invention, certain compounds identified may be used as an additive in coating formulations to promote curing of a coating resin with diluents. For example allyl-containing titanate esters described in this invention may be used a low concentrations in coating formulations as a curing promoter. In such use, 0.1 wt. % to 5 wt. %, typically 0.2 to 2.5 wt. % and more typically 0.3 to 0.8 wt. %, of such titanate ester may be incorporated into a coating formulation as a curing promoter. Such promoter may be incorporated at low levels in a coating formulation or may be added separately in higher concentrations before use.

In addition to air or oxidative curing, coating formulations containing allyl esters of this invention may be cured partially or completely by using ultra-violet (uv) radiation. Further, dual curing may be applied in which a coated substrate is partially cured by air drying (oxidative) and partially by uv curing. In a typical use, a substrate with a covered with a coating formulation containing an alkyd or other suitable resin together with a reactive diluent of this invention may be subjected to uv radiation to accelerate the curing process. Ultra-violet curing may be useful especially in industrial applications.

An advantage of certain reactive diluents of this invention is an ability to form polymer networks during a curing process, such as siloxane linkages, or form finely divided oxide particles such as titanium dioxide.

The formulations may contain further components such as catalyst, drier, antiskinning agent, pigments and other additives. The formulations also may need to include water scavengers such as molecular sieves or zeolites where the reactive diluent used is susceptible to hydrolysis. Furthermore, where such water scavengers are used it may be necessary to use them in combination with pigment stabilizers. Where a drier is used this may further contribute towards the solvent content of the formulation.

The diluents of the present invention can be used in a range of resin binder systems including alkyds used in conventional high solids and solvent-free decorative paints, where necessary in the presence of a thinner such as white spirit. These diluents also may be used in other resin systems, especially where oxidative drying and double bonds characterise the binder system. Examples of the latter type are unsaturated polyesters, fatty acid modified acrylics, and the like. Such systems are known to the art. For effective use with the reactive diluents of this invention, a paint or coating system suitably contains a resin or binding system (such as alkyd) that will react with the reactive diluent to form chemical bonds, typically upon drying (curing). Such reaction may be with reactive sites, such as carbon-carbon double bonds or through an oxidative process. The reaction of the binding system with the reactive diluent inhibits release of volatile materials during a coating drying or curing phase.

For some uses it is preferable that the free alcohol content of the diluent is minimised in order to facilitate drying of the formulation.

The present invention is further illustrated, but not limited, by the following Examples.

### EXAMPLES

General Preparative Methods:

Preparation of trialkenyl borates:

All manipulations were carried out under a nitrogen atmosphere. All allyl alcohols and allylic ethers derivatives were distilled before use in the preparations of the borates. The 2,7-octadienol was obtained from Fluka Chemicals. The 2-ethylhexenol (2-ethylhex-2-en-1-ol) was prepared by sodium borohydride reduction of 2-ethylhexenal. The isophorol (3,5,5-trimethyl-2-cyclohexen-1-ol) was obtained from Aldrich. The triethylborate was used as supplied by Aldrich Chemical Co.

The 2-(2,7-octadienoxy)ethanol and the octadienoxy diglycol ether were prepared by the palladium catalysed telomerisation with butadiene of ethylene glycol and diethylene glycol, respectively. Octadienoxy ethanol prepared by telomerisation is a mixture of two major isomeric forms, with the linear isomer being the major form:

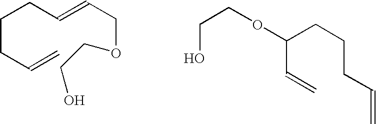

The mixed isomeric compounds, 1-(2,7-octadienoxy)propan-2-ol and 2-(2,7-octadienoxy)propan-1-ol were prepared by the reaction of 2,7-octadienol with propene oxide and purified by distillation. No attempt was made to separate the two isomers of which the secondary alcohol was major component:

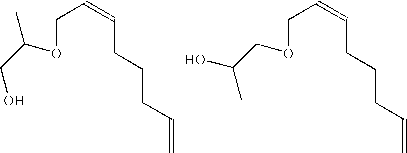

Similarly 1-(2-ethylhex-2-en-1-oxy)propan-2-ol and 2-(2-ethylhex-2-en-1-oxy)propan-1-ol were prepared by the reaction of 2-ethylhex-2-en-1-ol with propene oxide. In addition to this the dipropoxylated derivative of 2-ethylhexenol was prepared by further reaction with propene oxide.

In preparation of allyl derivatives of this invention, a three-necked Pyrex Quickfit® round-bottomed flask was equipped with two side arms, a magnetic follower and a heater stirrer mantle. The top of each of the three necks of the flask was connected respectively to a packed column, a liquid heads take off assembly, and a controllable source of vacuum or nitrogen top cover. The temperature of the flask contents was controlled by means of a thermocouple inserted into one of the flask side arms. The remaining side arm, when not stoppered, was used for purging the apparatus with nitrogen prior to use and for charging the reactants. The apparatus was purged with nitrogen to displace any air and moisture, then allylic alcohol was added to the flask. The allylic alcohol was purged of any oxygen by means of a nitrogen sparge.

Once degassed, the triethylborate was added. Slightly less than three equivalents of allyl ether alcohol or allyl alcohol (i.e., 2.9 to 3) were used per mole of borate. This procedure was adopted to prevent residual free alcohol, but the product will contain low levels of ethoxy groups.

Typically, the mixture was heated to 100° C. for two hours during which ethanol distilled across. The apparatus than was evacuated to 20 mbar and heated to 130° C. to complete the reaction. The progress of the reaction and distillation was monitored by gas chromatography. A target was set of less than 2% free alcohol in the kettle product. Once this had been achieved the reaction mixture was allowed to cool to room temperature and filtered through a short bed of celite filter aid to remove any particulates. The identity of the product was confirmed by gas chromatography (GC) and ¹H, ¹³C and ¹¹B nuclear magnetic resonance (NMR) analysis.

The following compounds were prepared by this method (note only the major isomer is named in these compounds):
Tri-(2-ethyl allyl)borate
Tri-(mesityl)borate (using mesityl alcohol).
Tri-(2,7-octadienyl)borate
Tri-(2-ethylhex-2-enyl)borate
Tri-(3,5,5-trimethyl-2-cyclohexen-1-yl)borate
Tri-(2-(2,7-octadienoxy)ethyl)borate
Tri-(2-(2-(2,7-octadienoxy)ethoxy)ethyl)borate
   Preparation of tetraalkenyl titanates

Apparatus, reactants, and procedures were used similar to that described above for preparation of trialkenyl borates. Tetra ethyl titanate was used as supplied by Aldrich Chemical Co. The 2-(2,7-octadienoxy)ethanol and the octadienoxy diglycol ether were prepared by the palladium catalysed telomerisation with butadiene of ethylene glycol and diethylene glycol, respectively.

An apparatus as previously described was purged with nitrogen to displace any air and moisture then the allylic alcohol was added to the flask. Allylic alcohol was purged of any oxygen by means of a nitrogen sparge. Once degassed, tetra ethyl titanate was added. Slightly less than four equivalents of allyl ether alcohol or allyl alcohol (3.9 to 4) were used per mole of titanate. As with the borate preparations, this procedure was adopted to prevent any residual fee alcohol, but the product as a result still contained low levels of ethoxy groups.

Typically, the mixture was heated to 100° C. for two hours during which ethanol distilled across. The apparatus was than evacuated to 20 mbar and heated to 130° C. to complete the reaction. The progress of the reaction and distillation was monitored by gas chromatography. A target was set of less than 2% free alcohol in the kettle product. Once this had been achieved the reaction mixture was allowed to cool to room temperature and filtered through a short bed of celite filter aid to remove any particulates. The identity of the product was confirmed by GC and ¹H and ¹³C NMR analysis.

The following compounds were prepared by this method (note only the major isomer is named in these compounds):
Tetra-(2,7-octadienyl)titanate
Tetra-(2-ethylhex-2-enyl)titanate
Tetra-(2-(2,7-octadienoxy)ethyl)titanate

Methyl tri allyloxysilanes and tetra allyloxysilanes

Apparatus, reactants, and procedures were used similar to that described above for preparation of trialkenyl borates. Ethyl orthosilicate, phenyl triethoxysilane, methyl triacetoxysilane and silicon (iv) acetate were used as supplied by Aldrich Chemical Co.

2-(2,7-Octadienoxy)ethanol (also called octadienoxyglycol ether) and the corresponding octadienoxy diglycol ether and the mixed isomeric compounds, 1-(2,7-octadienoxy)propan-2-ol and 2-(2,7-octadienoxy)propan-1-ol were prepared as previously described.

Similarly the 1-(2-ethyl hex-2-en-1-oxy)propan-2-ol and 2-(2-ethyl hex-2-en-1-oxy)propan-1-ol were prepared by reaction of 2-ethyl hex-2-en-1-ol with propene oxide. In addition, the dipropoxylated derivative of 2-ethylhexenol was prepared by further reaction with propene oxide.

An apparatus as previously described was purged with nitrogen to displace any air and then the allylic alcohol was added to the flask. The allylic alcohol was purged of any oxygen by means of a nitrogen sparge. Once degassed, acetoxy silane was added. An excess (1.05 equivalents) of allylic alcohol was used per acetoxy functionality in the silane.

The mixture was evacuated to about 20 mbar and heated to 80° C. for two hours. During this period, displaced acetic acid was collected from the top of the column. The reaction temperature was then raised to 120° C. and held for 4 hours to complete the reaction. The applied vacuum was then increased to 1 mbar to distil across any unreacted alcohol together with a minor by-product of acetate ester of the alcohol. It was found that use of a vacuum for the reaction was beneficial as it reduced the amount of esterification by rapid disengagement of the acetic acid by-product. It was also found that application of a vacuum of 1 mbar at the start of the reaction caused sublimation of the silane reactant.

The progress of the reaction and distillation was monitored by gas chromatography. A target was set of less than 2% free alcohol in the kettle product. Once this had been achieved the reaction mixture was allowed to cool to room temperature and filtered through a short bed of celite filter aid to remove any traces of silica/hydrated silicon oxides. The silicon acetate was found to contain as an impurity some silica. Additional silica may be formed during the course of the reaction if esterication and consequent water production (hydrolysis) is not kept to a minimum. The identity of the product was confirmed by GC and ¹H, ¹³C and ²⁹Si NMR analysis.

The following compounds were prepared by this method;
Methyl tri-(2-ethylallyl-1-oxy)silane
Tetra(2-ethylallyl-1-oxy)silane
Methyl tri-(2,7-octadienoxy)silane
Tetra-(2,7-octadienoxy)silane
Methyl tri-(2-ethylhex-2-enoxy)silane
Tetra-(2-ethylhex-2-enoxy)silane
Methyl tri-(3,5,5-trimethyl-2-cyclohexen-1-oxy)silane
Tetra-(3,5,5-trimethyl-2-cyclohexen-1-oxy)silane

The allyl ether-alcohol compounds were also prepared by a modification of the above method due to the low volatility of the ethoxylated and propoxylated allyllic alcohols precluding convenient distillation of excess unreacted alcohol or by-product ester. In these cases, only one equivalent of alcohol per acetoxy group was used and prior to heating to 80° C., the mixture was allowed to “pre-equilibrate” at room temperature for 2-24 hours at 1 mbar and all subsequent stages were carried out at 1 mbar. The low temperature pre-equilibration was found to prevent sublimation of the acetoxy silane reagent and to minimise any unwanted esterification reactions. Listed below are typical compounds prepared by this route, with naming of only the major isomer.
Methyl tri-(2-(2,7-octadienoxy)ethoxy)silane
Tetra-(2-(2,7-octadienoxy)ethoxy)silane
Methyl tri-(2-(2-(2,7-octadienoxy)ethoxy)ethoxy)silane
Tetra-(2-(2-(2,7-octadienoxy)ethoxy)ethoxy)silane
Tetra-(1-(2,7-octadienoxy)propan-2-oxy)silane
Tetra-(1-(2-ethylhex-2-en-1-oxy)propan-2-oxy)silane
Tetra-(1-(1-(2-ethylhex-2-en-1-oxy)propan-2-oxy)propan-2-oxy)silane
   Reaction of an Allylic Ether-Alcohol or Allylic Alcohol with an Alkoxysilane

An apparatus as previously described was purged with nitrogen to displace any air and moisture, and then the allylic alcohol was added to the flask. The allylic alcohol was purged of an oxygen by means of a nitrogen sparge. Once degassed, the alkoxysilane was added (e.g. ethyl orthosilicate or phenyl triethoxysilane). An approximately equal molar amount (0.95-1.05 equivalents) of allylic alcohol was used per alkoxy functionality in the silane. A transesterification/esterification catalyst (e.g. dibutyl tin oxide) was added at typically 0.1-1% wow based on the weight of reactants in the flask.

The contents of the flask were heated to 160° C. under a nitrogen atmosphere during which any displaced low boiling point alcohols were collected in the heads take off. This distillation was continued until heads material ceased to be collected. The reaction pressure was then lowered to 50 mmHg and held for 6 hours to complete the reaction. The applied vacuum was then increased to 1 mbar to distil across any unreacted alcohol.

The progress of the reaction and distillation was monitored by gas chromatography. A target was set of less than 2% free alcohol in the kettle product. Once this had been achieved the reaction mixture was allowed to cool to room temperature and filtered through a short bed of chromatography grade silica to remove the dibutyltin oxide catalyst. The identity of the product was confirmed by GC and ¹H, ¹³C and ²⁹Si NMR analysis.

The following compounds were prepared by this method;
Phenyl tri-(2-ethylhex-2-en-1-oxy)silane
Tetra(2,7-octadienoxy)silane
Tetra(2-ethylhex-2-en-1-oxy)silane.
   Preparation of tri allyloxy orthoformates

All manipulations were carried out under a nitrogen atmosphere. All the allylic alcohols and derivatives of allylic ether alcohols were distilled before use in the preparations of the orthoesters. The octadienol was obtained from Fluka Chemicals. The 2-ethylhexenol (2-ethylhex-2-en-1-ol) was prepared by a sodium borohydride reduction of 2-ethylhexenal. The triethylorthoformate and acetate were used as supplied by Aldrich Chemical Co. The 2-(2,7-octadienoxy)ethanol and the octadienoxy diglycol ether were prepared by the palladium catalysed telomerisation with butadiene of ethylene and diethylene glycol, respectively.

An apparatus as previously described was purged with nitrogen to displace any air and moisture, then the allylic alcohol was added to the flask. The allylic alcohol was purged of any oxygen by means of a nitrogen-sparge. Once degassed the orthoformate was added, 2.9 to 3 equivalents of allylic alcohol were used per mole of orthoester.

The mixture was heated to 100° C. for six hours and then to 120° C. for a further 6 hrs during which ethanol distilled across. The apparatus than was evacuated to 20 mbar and heated to 130° C. to complete the reaction. The progress of the reaction and distillation was monitored by gas chromatography. A target was set of less than 2% free alcohol in the kettle product. Once this had been achieved the reaction mixture was allowed to cool to room temperature and filtered through a short bed of celite filter aid to remove particulates. The identity of the product was confirmed by GC and ¹H and ¹³C NMR analysis.

The following compounds were prepared by this method (note: only the major isomer is named in these compounds):
Tri-(2,7-octadienyl)orthoformate
Tri-(2-ethylhex-2-enyl)orthoformate
Tri-(2-(2,7-octadienoxy)ethyl)orthoformate

Note that use of slightly less than three equivalents of the allylic ether alcohol or allylic alcohol prevented any residual free alcohol but the product as a result still contains low levels of ethoxy groups.

Reactive Diluents/Paint Formulation Testing

A good reactive diluent must meet a range of criteria including low odour and toxicity, low viscosity and the ability to “cut” the viscosity of the paint to facilitate application on the surface to be coated therewith. Furthermore, the diluent should not have a markedly adverse effect on the properties of the paint film such as drying speed, hardness, degree of wrinkling, durability and tendency to yellowing. The reactive diluents described above have therefore been tested in paint applications using clear paints. The diluents have been compared with paints formulated using white spirit, a conventional thinner.

Unpigmented “Clearcoat” Formulations

Unpigmented (“clearcoat”) paint formulations were prepared using a high solids alkyd resin SETAL® EPL 91/1/14 (ex AKZO NOBEL, and described in “Polymers Paint and Colour Journal, 1992, 182, pp. 372). In addition to the diluent, Siccatol® 938 drier (ex AKZO NOBEL) and methyl ethyl ketone-oxime (hereafter “MEK-oxime”) anti-skinning agent were used. Where used, the white spirit was Exxon type 100.

The nominal proportions of the above materials in the paint formulations were:

| Materials | Parts by weight |
|---|---|
| Resin + Diluent | 100.0 |
| Siccatol 938 | 6.7 |
| MEK-oxime | 0.5 |

Note that, for white spirit formulations only, the proportions of drier and antiskinning agent were calculated on the basis of the resin only. Thus, the concentration of these components in the paint was lower than for other diluents.

Alkyd resin and diluent were mixed in glass jars for 2 hours (e.g. using a Luckham multi-mix roller bed) in the proportions required to achieve a viscosity (measured via the ICI cone and plate method using a viscometer supplied by Research Equipment (London) Limited) of 6.8±0.3 poise (680±30 mPa·s). Typically, this resulted in a mixture which was ca. 85% w/w resin. If further additions of diluent or resin were required to adjust the viscosity to 6.8±0.3 poise (680±30 mPa·s), a further hour of mixing was allowed. The required quantity of drier was added and, after mixing (1 hour), the required amount of anti-skinning agent was added. After final mixing for at least 30 minutes, the viscosity of the mixture was measured to ensure that the viscosity was between 6.1 and 6.9 poise (610-690 mPa·s).

The mixture (“formulation”) was divided into two jars so as to leave ca. 10-15% v/v headspace of air in the sealed jars. One of the jars was stored at 23° C. in darkness for 7 days before paint applications tests were performed. The second jar was stored (“aged”) at 35° C. in daylight for 14 days before applications tests were performed.

Clearcoat Formulations Test Procedures:

Application of paint film:

Thin films were applied to cleaned glass test plates using Sheen cube or draw-bar applicators with a nominal 75 μm gap width.

Viscosity:

The viscosity of each formulation was measured according to BS 3900 Part A7 with an ICI cone and plate viscometer (supplied by Research Equipment (London) Limited) at 23° C. and at a shear rate of 10,000 reciprocal seconds.

The viscosity cutting power (“let-down” or “dilution” effect) of each diluent was measured with the above instrument and using mixtures of alkyd and diluent with a range of compositions. “Let-down” curves were plotted as % Solids (resin) versus Viscosity (poise). The viscosity of each diluent was measured at 23° C. using a suspended level viscometer. Densities of the diluents were taken as an average of three readings made at 23° C. using density bottles with a nominal 10 cm³ capacity, calibrated with water.

Drying Performance:

Drying performance was measured using films applied to 30 cm×2.5 cm glass strips and BK drying recorders. The BK recorders were enclosed in a Fisons controlled temperature and humidity cabinet so that the drying experiment could be performed at 10° C. and at 70% relative humidity. Sample performance was assessed on the basis of the second stage of drying (dust drying time, T2).

Pencil Hardness:

Films applied to 20 cm×10 cm glass plates were dried for 7 days on the laboratory bench at 23° C. and 55% relative humidity. The pencil hardness of each sample was measure using the method described in ASTM No. D3363-74. Each plate was then heated at 50° C. (4 days) and the pencil hardness measurement was repeated.

Incorporation of the Diluent into the Paint Film:

For some of the reactive diluents described below, further evidence of the degree of incorporation of the reactive diluent into the paint film was obtained. A good “reactive” diluent should, rather than evaporating, form chemical bonds with the resin and become bound into the polymer network of the dried paint film. The amount of diluent which evaporated during drying, and the amount of diluent which could be extracted from the cured paint film, and therefore was not bound into the polymer network, was determined.

It is well known by those skilled in the art that day-to-day fluctuations in conditions can introduce some variability into experimental data. To minimise these errors, the tests presented below were conducted as follows: five to eight paint formulations were prepared simultaneously and comprised one reference (white spirit) and 4-7 reactive diluent-based paints. These samples were tested at the same time under identical conditions. Comparison of performance data from within these groups of formulations allowed errors due to random sources to be minimised. Hence in the following examples, the apparent variation in performance data from some diluents results from the use of different paint formulations made on different days from the same diluent.

Results of Testing Reactive Diluents in Clearcoat Formulations:

The following Examples demonstrate that the compounds described above are suitable for use as reactive diluents in paint formulations. The Examples show also the control which can be exercised over the properties of the paint film by modification of the reactive diluent by using allyl ethers according to the invention described in this specification.

Tables 1 and 1A show that the diluents described in this specification have relatively low viscosity.

TABLE 1

| | Solvent viscosity |
|---|---|
| Solvent | (mPa · s, at 23 C.) |
| Tri (2-ethyl hexenoxy) borane | 7.2 |
| Tri (octadienoxy) borane | 11.2 |
| Tri (2-(2,7 octadienoxy) ethoxy) borane | 18.08 |
| Tri (2-(2-(2,7 octadienoxy) ethoxy) ethoxy) borane | 20.5 |
| Tetra (octadienyl) titanate | 75.55 |
| Tetra-(2-(2,7 octadienoxy) ethyl) titanate | 74.63 |

TABLE 1A

| | Solvent viscosity |
|---|---|
| | (mPa · s, |
| Solvent | at 23 C.) |
| Methyl tri(isophoroxy) silane | 108.4 |
| Tetra(isophoroxy) silane | 1499.2 |
| Methyl tri(2-ethyl hexenoxy) silane | 5.9 |
| Tetra(2-ethyl hexenoxy) silane | 10.3 |
| Methyl tri(octadienoxy) silane | 5.5 |
| Tetra(octadienoxy) silane | 13.9 |
| Tetra(2-(2,7 octadienoxy) ethoxy) silane | 15.6 |
| Tetra(2-(2-(2,7 octadienoxy)ethoxy)ethoxy) silane | 30.1 |
| Phenyl tri(2-ethyl hexenoxy) silane | 10.47 |
| Bis(2,7 octadienyoxy) bis(2-(2,7 octadienoxy) ethoxy)) | 8.56 |
| silane | |
| 2-Ethyl hexenyl ortho formate | 4.69 |
| Octadienyl ortho formate | 7.01 |

Tables 2A, 2B and 2C summarise acceptable drying time and hardness measurements from allyloxy derivatives of boron and titanium of this invention:

TABLE 2A

| | Drying | |
|---|---|---|
| | time (T2, Hrs) | |
| Solvent | Fresh | Aged |
| Tri (octadienoxy) borane | 7.7 | 8.4 |
| Tri (2-(2,7 octadienoxy) ethoxy) borane | 5.8 | 6.3 |
| Tri (2-(2-(2,7 octadienoxy) ethoxy) ethoxy) borane | 7 | 7.3 |
| White spirit | 3.4 | 3.6 |
| Tetra (octadienyl) titanate | 0.25 | 0.1 |
| Tetra-(2-(2,7 octadienoxy) ethyl) titanate | 5 | 7.1 |
| White spirit | 3.65 | 3.85 |

TABLE 2B

| | Pencil hardness measurements | | | |
|---|---|---|---|---|
| | Initial | | Final | |
| Solvent | Pencil | Scratch | Pencil | Scratch |
| Tri(octadienoxy) borane | ˜4B | ˜3B | 2B | B |
| Tri(2-(2,7 octadienoxy) | 4B | 3B | 2B | B |
| ethoxy)borane | | | | |
| Tri-2-(2-(2,7 | 4B | 3B | 2B | B |
| octadienoxy)ethoxy) ethoxy) | | | | |
| borane | | | | |
| White spirit | 4B | 3B | 4B | 3B |
| Tetra(octadienyl) titanate | 4B | 3B | B | HB |
| Tetra-(2-(2,7 octadienoxy)ethyl) | 4B | 3B | B | HB |
| titanate | | | | |
| White spirit | 4B | 3B | 2B | B |

TABLE 2C

Drying
Time
(T2, hours at
10 C., 70% RH)

| Solvent | Fresh | Aged |
|---|---|---|
| Methyl tri(2-ethyl hexenoxy) silane | 4.4 | 3.7 |
| Methyl tri(2,7 octadienoxy) silane | 4.6 | 4.1 |
| Methyl tri(isophoroxy) silane | 4.7 | 4.4 |
| Tetra(2-ethyl allyloxy) silane | 4.3 | 3.2 |
| White spirit | 3.3 | 3.3 |

Alkoxylated Allylic Alcohols:

Allylic alcohol described in this invention also may be used in their alkoxylated form for reaction with the boron/titanium compounds. This alkoxylation can be achieved via the reaction of e.g. ethylene oxide or propylene oxide with the allylic alcohol.

Addition of ethylene glycol or propylene glycol units to the allylic alcohol may be used to influence the performance of the diluent. For example, the alkoxylated allylic alcohol have reduced odour. Too many glycol units added to the allylic alcohols may result in soft films. Tables 2a and 2b show acceptable drying and hardness data from films containing diluents made with alkoxylated allylic alcohols.

Incorporation of Diluent into the Paint Film:

The results in Table 3 (in wt. %) show that the diluents described above are incorporated into the paint film through molecular bonding and show the low level of loss due to evaporation/extraction of the diluents.

TABLE 3

| | Extractable | Volatile | Incorporated |
|---|---|---|---|
| Solvent | Solvent | Solvent | Solvent |
| Tri(octadienyl) borane | 1.0 | 0.1 | 99 |
| Tri(octadienyl) borane | 0.6 | 0.7 | 99 |
| Tri(2-(2,7 octadienoxy)ethoxy) | 0.4 | 0.0 | 100 |
| borane | | | |
| Tri(2-(2,7 octadienoxy)ethoxy) | 0.3 | 0.0 | 100 |
| borane | | | |
| Tri (2-(2-(2,7 octadienoxy) ethoxy) | 9.8 | 0.0 | 90 |
| ethoxy) borane | | | |
| Tri (2-(2-(2,7 octadienoxy) ethoxy) | 7.3 | 0.3 | 93 |
| ethoxy) borane | | | |

Effect of the Number of Allylic Groups:

Control of the number of allylic group allows the paint formulator to achieve a rapid drying time and desirable film hardness. The drying time and pencil hardness data in Table 4A and 4B, respectively, show that diluents with three or four octadienoxy groups dry more rapidly and form harder films than a diluent with only one octadienoxy group. As shown in Table 1, viscosity must also be considered when choosing the number of allylic groups in the diluent.

TABLE 4A

| | Drying time after storage at 23° C. |
|---|---|
| Solvent | (7 days)(T2, Hrs @ 10° C., 70% RH) |
| Tetra(octadienoxy) silane | 4.4 |
| Methyl tri(octadienoxy) silane | 4.9 |
| Tri(n-butyl)octadienoxy silane | 5.8 |
| White Spirit | 3.4 |

TABLE 4B

| | Pencil hardness measurements | | | |
|---|---|---|---|---|
| | Initial | | Final | |
| Solvent | Pencil | Scratch | Pencil | Scratch |
| Tri(n-butyl)octadienoxy silane | <6B | 6B | 5B | 4B |
| Methyl tri(octadienoxy) silane | 4B | 3B | ˜2B | ˜B |
| Tetra(octadienoxy) silane | 4B | 3B | 3B | 2B |
| White spirit | 4B | 3B | 3B | 2B |

Effect of the Central Metal Atom:

Diluents with silicon and carbon as the central atom gave films with drying times within ca. 2 hours of the white spirit based formulations and which were of similar hardness (Table 5A and 5B). This is regarded as acceptable by the industry.

TABLE 5A

Drying
time (T2, Hrs)

| Solvent | Fresh | Aged |
|---|---|---|
| Methyl tri(2-ethyl hexenoxy) silane | 4.4 | 3.7 |
| Methyl tri(octadienoxy) silane | 4.6 | 4.1 |
| White spirit | 3.3 | 3.3 |
| 2-ethyl hexenyl orthoformate | 4.6 | 4.65 |
| Octadienyl orthoformate | 5 | 4.75 |
| White spirit | 3.2 | 4 |

TABLE 5B

| | Pencil hardness measurements | | | |
|---|---|---|---|---|
| | Initial | | Final | |
| Solvent | Pencil | Scratch | Pencil | Scratch |
| Methyl tri(octadienoxy) silane | 4B | 3B | ˜2B | ˜B |
| Octadienyl orthoformate | 4B | 3B | 2B | B |
| 2-ethyl hexenyl orthoformate | 4B | 3B | 3B | 2B |
| White spirit | 4B | 3B | B | HB |

The excellent incorporation of the diluents (wt %) described in this specification when compared with extractable solvents is shown in Table 6. In these experiments no volatile solvents were observed.

TABLE 6

| | Extractable | Incorporated |
|---|---|---|
| Solvent | Solvent | Solvent |
| 2-ethyl hexenyl ortho formate | 0.5 | 100 |
| 2-ethyl hexenyl ortho formate | 0.4 | 100 |
| Octadienyl ortho formate | 6.8 | 93 |
| Octadienyl ortho formate | 7.8 | 92 |
| Methyl tri(octadienoxy) silane | 0.3 | 100 |
| Methyl tri(ctadienoxy) silane | 0.2 | 100 |
| Tetra(2-ethyl hexenoxy) silane(98%) | 0.0 | 100 |
| Tetra(2-ethyl hexenoxy) silane(98%) | 0.0 | 100 |

Effect of Alkoxylated Allylic Alcohols

The allylic alcohol can also be used in its alkoxylated form for reaction with the silicon/carbon compounds. This alkoxylation can be achieved via the reaction of e.g. ethylene oxide or propylene oxide with the allylic alcohol. Alternatively, compounds such as 2-octadienoxy ethanol and 2-(2-ocatadienoxy ethoxy)ethanol can be prepared by the telomerisation of butadiene.

Addition of ethylene glycol or propylene glycol units to the allylic alcohol can be used to influence the performance of the diluent. For example, the alkoxylated allylic alcohol have reduced odour. If too many glycol units are added to the allylic alcohols, this may result in soft films. Tables 7A and 7B show acceptable drying and hardness data from films containing diluents made with alkoxylated allylic alcohols. Incorporation data are included in Table 6.

TABLE 7A

| | Pencil hardness measurements | | | |
|---|---|---|---|---|
| | Initial | Initial | Final | Final |
| Solvent | Pencil | Scratch | Pencil | Scratch |
| Methyl tri(octadienoxy) silane | 4B | 3B | ˜2B | ˜B |
| Methyl tri(2-(2,7 octadienoxy) | 4B | 3B | ˜4B | ˜3B |
| ethoxy) silane | | | | |
| Methyl tri-2-(2-(2,7 octadienoxy) | ˜5B | ˜4B | ˜4B | ˜3B |
| ethoxy) ethoxy) silane | | | | |
| Tetra(2,7 octadienoxy) silane | ˜4B | ˜3B | 2B | B |
| Tetra(2-(2,7 octadienoxy) | ˜5B | ˜4B | ˜3B | ˜2B |
| ethoxy) silane | | | | |
| Tetra(2-(2-(2,7 octadienoxy) | 4B | 3B | ˜B | ˜HB |
| ethoxy) ethoxy) silane | | | | |
| White spirit | 3B | 2B | ˜3B | ˜2B |

TABLE 7B

| | Drying | |
|---|---|---|
| | time (Hrs) | |
| Solvent | Fresh | Aged |
| Methyl tri(octadienoxy) silane | 5.2 | 5.2 |
| Methyl tri(2-(2,7 octadienoxy) ethoxy) silane | 5.6 | 4.8 |
| Methyl tri-2-(2-(2,7 octadienoxy) ethoxy) ethoxy) silane | 5.6 | 6.2 |
| Tetra(2,7 octadienoxy) silane | 5 | 4.4 |
| Tetra(2-(2,7 octadienoxy) ethoxy) silane | 4.7 | 4.1 |
| Tetra(2-(2-(2,7 octadienoxy) ethoxy) ethoxy) silane | 5.1 | 5.6 |
| White spirit | 3.6 | 3.5 |

Silane Used to Prepare the Diluent:

Table 8 compares drying times of diluents prepared from different silane starting materials.

TABLE 8

Drying Time
(hours)

| SOLVENT | Fresh | Aged |
|---|---|---|
| Tetra(2-ethyl hexenoxy)silane* | 4.05 | 3.6 |
| Tetra(2-ethyl hexenoxy)silane** | 4.35 | 3.6 |
| White Spirit | 3.45 | 2.8 |

*formed by reacting tetra-acetoxy silane with the allylic alcohol
**formed by reacting tetra-ethoxy silane with the allylic alcohol

1. A reactive diluent comprising one or more allyloxy derivatives of formula:
RₙM(OR′)ₓ(OR″)_{y}
wherein
M is selected from silicon, carbon, boron, and titanium;
R is selected from hydrogen and from hydrocarbyl and alkoxy groups containing up to 10 carbon atoms;
R′ are selected unsaturated hydrocarbyl or hydrocarbyloxy hydrocarbyl groups containing up to 22 carbon atoms, provided when M is boron or titanium, at least one R′ is a hydrocarbyloxy hydrocarbyl group;
R″ are selected from saturated analogues of R′; and
n=0 or 1 for carbon and silicon and =0 for boron and titanium.
x and y are numerical values for which x is at least 1 and y may be zero such that
if M is boron, n+x+y=3, and
if M is silicon, carbon, or titanium, n+x+y=4.

2. A reactive diluent according to claim 1 wherein R′ has the structure: 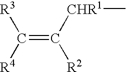
in which
R¹ is H or a C₁-C₄ alkyl group or a hydrocarbyloxy alkyl group containing up to 10 carbon atoms,
R² is H or a C₁-C₄ alkyl group or a hydrocarbyloxy alkyl group containing up to 10 carbon atoms,
R³ is H or a C₁-C₄ alkyl group,
R⁴ is H, a straight or branched chain alkyl group having up to 8 carbon atoms,
an alkenyl group having up to 8 carbon atoms,
an aryl group or an aralkyl group having up to 12 carbon atoms, or
a hydrocarbyloxy alkyl group having up to 10 carbon atoms, or,
R⁴, when taken together with R¹, forms a cyclic alkylene group with alkyl substituents therein and in which case R² is H.

3. A reactive diluent according to claim 1 wherein R′ is derived from allylic alcohols of: 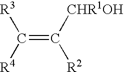
in which
R¹ is H or a C₁-C₄ alkyl group or a hydrocarbyloxy alkyl group containing up to 10 carbon atoms,
R² is H or a C₁-C₄ alkyl group or a hydrocarbyloxy alkyl group containing up to 10 carbon atoms,
R³ is H or a C₁-C₄ alkyl group,
R⁴ is H, a straight or branched chain alkyl group having up to 8 carbon atoms,
an alkenyl group having up to 8 carbon atoms,
an aryl group or an aralkyl group having up to 12 carbon atoms, or
a hydrocarbyloxy alkyl group having up to 10 carbon atoms, or,
R⁴, when taken together with R¹, forms a cyclic alkylene group with alkyl substituents therein and in which case R² is H.

4. A reactive diluent of claim 4 wherein the allyloxy derivatives of boron and titanium are tetra-allyl titanates or tri-allyl borates.

5. A reactive diluent of claim 1 derived from an allylic alcohol selected from: 2,7-octadienol; 2-ethyl-hex-2-en-1-ol; 2-ethyl allyl alcohol; hept-3-en-2-ol; 1,4-but-2-ene diol mono-tertiary butyl ether; 1,4-but-2-ene-diol mono α-methylbenzyloxy ether; 1,4-but-2-ene-diol mono α-di-methylbenzyloxy ether; 1,2-but-3-ene-diol mono hydrocarbyloxy alkylene ether; 2-hydrocarbyloxy alkylene allyl alcohol; and isophorol.

6. A reactive diluent of claim 2 selected from the group consisting of tri-(2-ethyl allyl)borate, tri-(mesityl)borate, tri-(2,7-octadienyl)borate, tri-(2-ethylhex-2-enyl)borate, tri-(3,5,5-trimethyl-2-cyclohexen-1-yl)borate, tri-(2-(2,7-octadienoxy)ethyl)borate, tri-(2-(2-(2,7-octadienoxy)ethoxy)ethyl)borate, tetra-(2,7-octadienyl)titanate, and tetra-(2-ethylhex-2-enyl)titanate.

7. A reactive diluent formulation comprising a reactive diluent of claim 1 in which M is titanium in combination with a reactive diluent of claim 1 wherein M is boron, silicon, or carbon.

8. A reactive diluent comprising a borate or titanate in which at least one ligand group derived from an allyl ether alcohol attached to a central M atom having a formula:
[R*O(CR⁶R⁷—CR⁸R⁹O)ₚ]ₙ-M
wherein:
R* is an saturated or unsaturated hydrocarbyl or hydrocarbyloxy hydrocarbyl group containing up to 22 carbon atoms, provided that in at least one ligand group, R* contains at least one allylic unsaturation;
M is boron (III) or titanium (IV) or silicon or carbon;
R⁶, R⁷, R⁸, and R⁹ are selected individually from hydrogen and alkyl, alkylene, and aryl groups containing up to 10 carbon atoms;
n is the valence of M; and
p is 0 to 5, provided that p is 1 for at least one ligand group.

9. A reactive diluent according to claim 8 wherein said diluent is selected from the group consisting of tri-(2-(2,7-octadienoxy)ethyl)borate, tri-(2-(2-(2,7-octadienoxy)ethoxy)ethyl)borate and tetra-(2-(2,7-octadienoxy)ethyl)titanate.

10. A reactive diluent according to claim 1 wherein said diluent has a boiling point above 250° C.

11. A reactive diluent according to claim 1 wherein said diluent has a viscosity below 1500 mPa·s.

12. A reactive diluent according to claim 11 wherein said diluent has a viscosity below 150 mPa·s.

13. A formulation suitable for application as a coating comprising a reactive diluent of claim 1 in combination with a binder system capable of reacting with the reactive diluent upon curing.

14. A formulation according to claim 13 in which the binder system is an alkyd resin system.

15. A formulation according to claim 14 comprising one or more of alkyd resins, unsaturated polyesters, and fatty acid modified acrylics.

16. A formulation according to claim 15 wherein the relative proportions of the reactive diluent to alkyd resin is in the range from 5:95 to 50:50 parts by weight.

17. A formulation according to claim 13 wherein said formulation contains in addition one or more further components selected from the group consisting of a catalyst, a drier, antiskinning agent, pigments, water scavengers and pigment stabilizers.

18. A formulation according to claim 13 capable of curing using ultraviolet radiation.

19. A formulation according to claim 13 capable of oxidative and uv curing.

20. A formulation according to claim 13 containing less than 5 wt. % of a titanate used as a curing promoter.

21. A formulation according to claim 13 containing a reactive diluent in which M is silicon.

22-23. (canceled)
